(19) United States
(12) Patent Application Publication
(10) Pub. No.: US 2021/0210109 A1
(43) Pub. Date: Jul. 8, 2021

(54) ADAPTIVE DECODER FOR HIGHLY COMPRESSED GRAPHEME MODEL

(71) Applicant: Knowles Electronics, LLC, Itasca, IL (US)

(72) Inventors: Fuliang Weng, Mountain View, CA (US); Alexei Ivanov, Marina, CA (US)

(21) Appl. No.: 17/134,402

(22) Filed: Dec. 26, 2020

Related U.S. Application Data
(60) Provisional application No. 62/957,072, filed on Jan. 3, 2020.

(51) Int. Cl. G10L 19/04; G10L 15/187

(52) U.S. Cl. CPC G10L 19/04; G10L 2015/088; G10L 15/187

(57) ABSTRACT

Systems, methods, and apparatuses are disclosed herein for automatic speech recognition (ASR) in devices with limited memory or power constraints. An ASR system may have an acoustic engine and a decoder to identify a spoken command from an input audio stream. A dynamic command list may be used to reduce the size of an adapted lexicon used by the decoder, where the dynamic command list is associated with a state of the system. The decoder may be expanded based on labelled speech samples input into a compressed acoustic model of the ASR system. Speech samples may be collected and integrated to be user-specific.

### TECHNICAL FIELD

The present disclosure relates generally to the field of speech processing systems, and more specifically, to improved speech recognition for compressed acoustic models.

### BACKGROUND

Speech recognition is used in a variety of applications, such as speech-to-text conversion, voice commands, and audio file processing. Speech recognition systems may be implemented in many electronic devices, such as, for example, smart speakers, smart TV's, gaming stations, and smart phones. Speech recognition may also be implemented within an Internet-of-Things network such that a user can interact with a variety of interconnected devices using spoken commands.

Typically, speech recognition is performed on a main processing circuit of the device or system. It is desirable to implement speech recognition on an edge device for improved privacy and always-available speech recognition. However, edge devices may generally have stricter power or memory constraints than a main processing circuit that may hinder a typical speech recognition system.

### SUMMARY

Various embodiments of the present application relate to an apparatus, comprising an adaptive decoder configured to determine a command from a sequence of graphemes, the sequence of graphemes generated using a compressed acoustic model, wherein the adaptive decoder can be expanded to recognize additional grapheme sequences, and wherein the additional grapheme sequences are hypothesis sequences generated by the compressed acoustic model using labeled speech utterances.

In some embodiments, the adaptive decoder is expanded responsive to the hypothesis sequences being different than a label sequence associated with the labeled speech utterances.

In some embodiments, the adaptive decoder comprises an adaptive lexicon, wherein the additional grapheme sequences are added to the entries in the adaptive lexicon.

In some embodiments, the adaptive decoder comprises an adaptive language model, wherein the adaptive lexicon with additional grapheme sequences are used to generate the adaptive language model.

In some embodiments, wherein the apparatus further comprises a trigger module configured to recognize a spoken keyword in an audio signal and send a control signal to the adaptive decoder responsive to recognizing the spoken keyword.

In some embodiments, the decoder is configured to use a dynamic command list.

In some embodiments, the dynamic command list is associated with a state or context of the apparatus.

In some embodiments, the apparatus further comprises an acoustic engine configured to generate the sequence of graphemes.

In some embodiments, the compressed acoustic model is stored in less than 4 MB of memory storage on a memory device.

In some embodiments, the acoustic engine is implemented by a digital signal processor and the adaptive decoder is implemented by an application processor separate from the digital signal processor.

In some embodiments, the adaptive decoder is implemented by a digital signal processor and the acoustic engine is implemented by an application processor separate from the digital signal processor.

In some embodiments, the acoustic engine and the adaptive decoder are implemented by a digital signal processor.

In some embodiments, the acoustic engine and the adaptive decoder are implemented by an application processor.

In some embodiments, the compressed acoustic model and the adaptive decoder are stored in less than 7 MB of memory storage on a memory device.

In some embodiments, the apparatus consumes less than 80 mW of power.

Various embodiments of the present application relate to an audio processing system comprising a decoder module configured to determine a command from a sequence of graphemes generated by a compressed acoustic model; and a decoder compilation module configured to receive a speech utterance and a grapheme sequence of a command corresponding to the speech utterance, generate a hypothesis grapheme sequence for the speech utterance using the compressed acoustic model, determine an error measurement between the hypothesis grapheme sequence to the command grapheme sequence, and expand the decoder module to recognize the hypothesis grapheme sequence responsive to the error measurement exceeding a threshold.

In some embodiments, the decoder compilation module is further configured to generate a confusion matrix for the compressed acoustic model, wherein the error measurement corresponds to a value in the confusion matrix.

In some embodiments, updating the decoder module comprises adding the hypothesis grapheme sequence to an adapted lexicon used by the decoder module.

In some embodiments, expanding the decoder module comprises recompiling a language model used by the decoder module using the hypothesis sequence.

In some embodiments, the command is included in a first set of commands the decoder module is configured to recognize, wherein the decoder compilation module is further configured to update the decoder module to recognize a second set of commands.

In some embodiments, the first set of commands is stored in the decoder module, wherein the second set of commands replaces the first set of commands.

In some embodiments, the first set of commands and the second set of commands are associated with a state or context of an application system.

In some embodiments, the processing system further comprises a trigger module configured to recognize a spoken keyword in an audio signal and send a control signal to the decoder module responsive to recognizing the subsequent spoken command and optionally confirming the spoken keyword.

Various embodiments of the present application relate to a method, the method comprising receiving a speech utterance and a grapheme sequence of a command corresponding to the speech utterance; generating a hypothesis grapheme sequence for the speech utterance using a compressed acoustic model; determining an error measurement between the hypothesis grapheme sequence to the command grapheme sequence; recompiling an adaptive decoder to recognize the hypothesis grapheme sequence responsive to the error measurement exceeding a threshold; and determining, using the recompiled adaptive decoder, a command from a sequence of graphemes, the sequence of graphemes generated by the compressed acoustic model.

In some embodiments, recompiling the adaptive decoder comprises adding the hypothesis grapheme sequence to an adapted lexicon used by the adaptive decoder.

In some embodiments, recompiling the adaptive decoder comprises generating a language model used by the decoder module using the hypothesis sequence.

In some embodiments, the command is included in a first set of commands the decoder module is configured to recognize, the method further comprising recompiling the adaptive decoder to recognize a second set of commands.

Various embodiments of the present application relate to another processing system comprising an adapted lexicon comprising a first set of commands; a decoder configured to use the adapted lexicon and determine a command from the grapheme sequence, the command included in the adapted lexicon; and a decoder compiler configured to determine a change of state or context of an application of the processing system, and determine a second set of commands for the adapted lexicon, wherein the second set of commands is associated with a new state or context; and recompile the adapted lexicon with the second set of commands.

Various embodiments of the present application relate to another method comprising compiling a decoder to recognize a first set of commands, the first set of commands associated with a first state; receiving a change of state of a device application; determining a second set of commands to compile on the decoder, wherein the second set of commands is associated with a second state of the device application; and recompiling the decoder with the second set of commands.

### BRIEF DESCRIPTION OF THE DRAWINGS

FIG. 1 is a diagram of a system for speech recognition, according to some embodiments.

FIG. 2 is a diagram of a dynamic command processing system, according to some embodiments.

FIGS. 3-6 are configurations of an adaptive speech recognition system, according to some embodiments.

FIG. 7 is a diagram of a system for automatically constructing an adaptive decoder for a speech recognition system, according to some embodiments.

FIG. 8 is a diagram of a training system for expanding an adaptive decoder, according to some embodiments.

FIG. 9 is a flow diagram of a method for expanding an adaptive decoder, according to some embodiments.

FIG. 10 is a flow diagram for implementing dynamic command list in an adaptive decoder, according to some embodiments.

### DETAILED DESCRIPTION

Overview

Referring generally to the figures, systems, methods, and apparatuses are shown for improved speech recognition in audio processing systems. Specifically, the methods and systems herein disclose a dynamic command-recognition system with improved recognition accuracy in systems with constrained hardware devices.

An automatic speech recognition (ASR) system may generally include an acoustic engine and a decoder. The acoustic engine transcribes spoken utterances from an audio stream into a sequence of phonetic or grapheme symbols using an acoustic model. The decoder receives the sequence of symbols from the acoustic engine and determines a voice command spoken by the user. The determined voice command can then be used by a processing system to perform an action or change a state of the system. In some implementations, a user may be prompted or required to use a trigger word or phrase (e.g. keyword) before speaking a command phrase. The trigger word or phrase may be used to activate components of the ASR system to reduce power consumption in idle states.

Previously, ASR algorithms have been performed by a system's main application processor (used interchangeably herein with central processing system or application processing system). Application processors may be understood to have fewer hardware constraints compared to other processing devices, such as DSP (digital signal processors) or edge processing devices, in the system. However, it is generally desirable to move ASR processing from the application processor to an edge processor (used interchangeably herein with edge processing system). By performing ASR processing on the edge processor, processing loads on the application processor are reduced. Additionally, edge processors generally have much lower power consumption than application processors, and thus can operate in a battery-powered always-on configuration, such as earbuds, smartphones, alarms. Third, since application processors generally include a network or internet interface, conversations processed by the application processor are susceptible to an outside breach; ASR on edge devices therefore preserves the privacy of a user's data with an additional layer of abstraction.

Edge processors may generally have reduced memory space or fewer processing circuits compared to the application processor in a distributed processing system. Small edge processors may be desired to reduce hardware cost and power consumption for an edge device. In implementations where the edge device is powered by a battery, the size or complexity of the edge processor may be limited by to meet a desired battery life of the edge device. In order to implement an ASR algorithm on an edge processor, one or more ASR models may be compressed to reduce the size and complexity of the ASR system. For example, an ASR system may use a compressed acoustic model to generate a sequence of graphemes from an audio signal with spoken language. However, by compressing the acoustic model, the system produces a higher error rate, which may hinder the performance of the system. In some embodiments, a grapheme acoustic model compressed to less than 3 MB produces a grapheme error rate of approximately over 10%.

The present application provides various solutions to this problem and others by adaptively expanding a speech decoder based on sample data processed using the compressed acoustic model. The methods and systems herein can identify grapheme sequences with the highest error rate in the compressed acoustic model and train the decoder to associate these sequences with the intended command. A specific user may also be prompted to recite a few sample phrases or commands such that speaker-specific sequences can also be added to the decoder. The systems and method can use interchangeable command lists to further reduce the storage size of the decoder, such that only commands relevant to the context of the current state of the system are loaded onto the decoder. The present application provides an advantage in that continuous ASR can be performed on an edge device with memory or power constraints with improved accuracy.

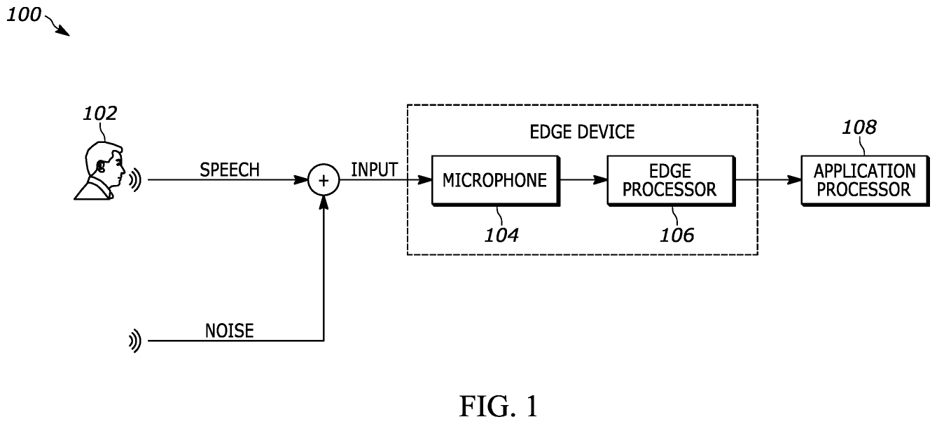

Referring now to FIG. 1, a diagram for a speech recognition system 100 using an edge processor is shown, according to one embodiment. System 100 includes a microphone 104, edge processor 106, and application processor 108. System 100 may be configured as a distributed system such that a spoken command received from a user 102 is processed by both the edge processor 106 and the application processor 108. The processing devices of system 100 may generally manage and execute a dynamic command recognition system to recognize commands spoken by user 102.

Edge processor 106 and application processor 108 may be configured within the same device. In some embodiments, edge processor 106 is configured in an edge device separate from a main device that comprises the application processor 108. The edge device may be, for example, a headset, earbud, headphones, smart speaker, smart microphone, or smart phone.

The microphone 104 may include one or more microphones or acoustic sensors configured to receive audio signals from an environment. The audio signal may include spoken language by the user 102 as well as noise from the environment. The microphone 104 may send the received audio signal to the edge processor 104. Additionally or alternatively, in some embodiments, the microphone 104 sends the received audio signal to the application processor 108. The edge device may further include additional components (not shown) to process the audio signal from the microphone 104, for example to reduce or otherwise ameliorate the effects of noise.

Edge processor 106 may be any processing device that performs one or more specific function within a processing system. Edge processor 106 can be implemented as a general purpose processor, one or more microprocessors, a digital signal processor, an application specific integrated circuit (ASIC), one or more field programmable gate arrays (FPGAs), a group of processing components, or other suitable electronic processing components. In some embodiments, edge processor 106 is a digital signal processor. Edge processor 106 may have one or more storage devices that store instructions thereon that, when executed by one or more processors, cause the one or more processors to facilitate the various processes described in the present disclosure. The one or more storages devices may include random access memory (RAM), read-only memory (ROM), hard drive storage, temporary storage, non-volatile memory, flash memory, optical memory, or any other suitable memory for storing software objects and/or computer instructions. Edge processor 106 may be configured to dynamically receive processing instructions, configuration files, or machine code from application processor 108 to determine processes to be performed by edge processor 106. For example, edge processor 106 may receive a compressed acoustic model or language model from application processor 108 and store the model in the one or more storage devices.

Edge processor 106 is communicably coupled to the application processor 108 through one or more communications interfaces. The one or more communications interfaces may include wired or wireless interfaces (e.g., jacks, antennas, transmitters, receivers, transceivers, wire terminals, etc.) for conducting data communications with various systems, devices, or networks. For example, the one or more communications interfaces may include a Bluetooth module and antenna for sending data to and receiving data from the application processor 108 via a Bluetooth-protocol network. As another example, the communications interfaces may include an Ethernet card and port for sending and receiving data via an Ethernet-based communications network or a WiFi transceiver for communicating via a wireless communications network. The one or more communications interfaces may be configured to communicate via local area networks or wide area networks (e.g., the Internet, a building WAN, etc.) and may use a variety of communications protocols.

Edge processor 106 may generally have stricter hardware constraints than application processor 108. Hardware constraints may be understood as limiting at least one of memory storage, power consumption, clock speed, number of processors, or processing speed of a device. For example, edge processor 106 may have less memory storage than the application processor 108. In addition or alternatively, edge processor 106 may have fewer processing circuits than application processor 108. A processing device may be constrained to reduce the cost of implementing the processing device, or reduce overall power usage of the application such that the constrained processing device can continuously process an audio stream for spoken commands (e.g., operate in an always-on mode).

Application processor 108 may be one or more processing circuits that execute and/or facilitate the process flow of the main device or system. Application processor 108 can be implemented as a general purpose processor, one or more microprocessors, a digital signal processor, an application specific integrated circuit (ASIC), one or more field programmable gate arrays (FPGAs), a group of processing components, or other suitable electronic processing components. Application processor 108 may be configured to receive computer instructions stored on one or more storage devices incorporated into application processor 108 or received from other computer readable media (e.g., CDROM, network storage, a remote server, etc.) that, when executed by one or more processors, cause the one or more processors to facilitate the various processes described in the present disclosure. The one or more storages devices may include random access memory (RAM), read-only memory (ROM), hard drive storage, temporary storage, non-volatile memory, flash memory, optical memory, or any other suitable memory for storing software objects and/or computer instructions. Application processor 108 may include database components, object code components, script components, or any other type of information structure for supporting the various activities and information structures described in the present disclosure.

Application processor 108 is communicably coupled to the edge processor 106 through one or more communications interfaces. The one or more communications interfaces may include wired or wireless interfaces (e.g., jacks, antennas, transmitters, receivers, transceivers, wire terminals, etc.) for conducting data communications with various systems, devices, or networks. For example, the one or more communications interfaces may include a Bluetooth module and antenna for sending data to and receiving data from the edge processor 106 via a Bluetooth-protocol network. As another example, the communications interfaces may include an Ethernet card and port for sending and receiving data via an Ethernet-based communications network or a WiFi transceiver for communicating via a wireless communications network. The one or more communications interfaces may be configured to communicate via local area networks or wide area networks (e.g., the Internet, a building WAN, etc.) and may use a variety of communications protocols. In addition, application processor 108 may be configured to access servers and data other than edge processor 106 to send and receive data. For example, application processor 108 may be configured to receive models or training data from another server via the Internet.

In various embodiments of the present application, the adaptive ASR system can be implemented on the edge processor 106 and application processor 108 in less than about 7 MB of memory storage. In some embodiments, the adaptive ASR system can be implemented in less than about 5 MB of memory storage. A compressed acoustic model may be used in the present application that is stored in less than 4 MB of memory. The edge processor 106 implementing the adaptive ASR system may have a power consumption less than about 80 mW. In some embodiments, the edge processor 106 uses less than about 10 mW of power.

Adaptive ASR System

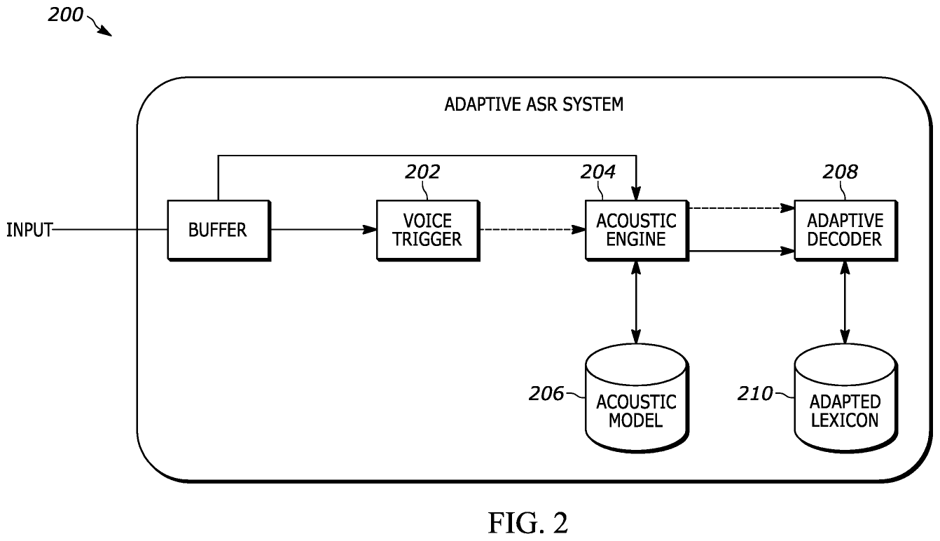

Referring now to FIG. 2, a block diagram for an adaptive command recognition (ACR) system 200 is shown, according to one embodiment. System 200 includes a voice trigger module 202, acoustic engine 204, and adaptive decoder 208. The acoustic engine 204 is shown to use an acoustic model 206. Adaptive decoder 208 is shown to use an adapted language model or an adaptive lexicon in a simple form 210. System 200 is configured receive an input audio stream and output a command phrase identified from the audio stream to an application processor. The various components of system 200 can be implemented as separate or combined configurations of circuit elements or software.

Voice trigger module 202 is configured to recognize a trigger keyword or phrase from the input audio stream. Voice trigger module 202 may also be configured to send a control signal to at least one of the acoustic engine 204 or the adaptive decoder 208 in response to identifying the trigger keyword or phrase. In one embodiment, the control signal causes the acoustic engine 204 and/or adaptive decoder 208 to wake up from a sleep-state or low-power state and begin processing the audio signal. The voice trigger module 202 may provide an anchoring point for the subsequent command phrase in the audio signal. Voice trigger module 202 may be configured to associate a time stamp with the spoken command or otherwise indicate the starting point of the subsequent command phrase to the acoustic engine 204. In some embodiments, the audio stream is stored in a buffer accessible by the voice trigger module 202 and acoustic engine 204. Data from the audio stream may be grouped into finite audio signals to be processed in the ASR system as discrete-time features. In some embodiments, the audio signals overlap in time.

Acoustic engine 204 is configured to generate a sequence of graphemes from an audio signal. Acoustic engine 204 can retrieve an acoustic model 206 from memory and use the acoustic model 206 to generate the sequence of graphemes. Acoustic engine 204 may identify frequency-domain or time-domain features of the acoustic signal. Acoustic engine 204 can discriminate the permitted commands from non-commands. The input to the acoustic engine 204 includes the audio signal and a starting point in the stream for grapheme or phonetic conversion. In the embodiments of the present application, the acoustic model 206 is a compressed acoustic model. Acoustic model 206 may be compressed according to any compression algorithm, such as, for example, quantization or structural complexity reduction. Acoustic model 206 may be a hard classifier (i.e., outputs the predicted grapheme) or a soft classifier (i.e., determines a probability that a particular grapheme was spoken). Acoustic engine 204 may be configured to send a control signal to adaptive decoder 208 to indicate a grapheme sequence is ready to be processed.

Adaptive decoder 208 receives the sequence of graphemes from the acoustic engine 204 and determines a command spoken by the user. The adaptive decoder 208 may be configured to receive the output from the acoustic engine 204, and identify the intended command spoken by the user using the adapted lexicon 210 that associates grapheme sequences with words, phrases, or commands in a list. Adapted lexicon 210 could be a database of limited command entries, where the command entries have one or more associated grapheme sequences and the intended command. Adapted lexicon 210 may be incorporated into a language model, such as a finite-state transducer. In some embodiments, adapted lexicon 210 may be structured as a prefix tree or finite state network. In some embodiments, adaptive decoder implements a Hidden Markov Model (HMM).

The adapted lexicon 210 may be modified or recompiled to recognize additional grapheme sequences. For example, additional lexicon entries may be added to the adapted lexicon 210. The updated lexicon may be used to generate or modify a language model. The additional grapheme sequences may recover from prediction errors from the acoustic engine. The prediction error may be caused by the compression of the acoustic model 206. Model prediction error may be understood to mean misidentifying a grapheme, word, or command from the audio stream. The additional grapheme sequences may be selected to be added to the adapted lexicon 210 based on a measured error rate in training data used to compile adaptive decoder 208.

The adaptive decoder 208 uses the list of commands in the adapted lexicon 210 to limit the commands recognized by adaptive decoder 208 to only those commands relevant to a particular state of the system or context. For example, a device may operate in a locked mode and an unlocked mode, where the system accepts different commands in each mode. In another example, a device responds to a first set of commands while the user is in a home screen; thereafter, when the user launches an application on the device, the device responds to a second set of commands relevant to the application. Adaptive decoder 208 may be recompiled or expanded responsive to a determination of a state or context change. Dynamic command lists generally reduce the memory size of adapted lexicon 210 and adaptive decoder 208.

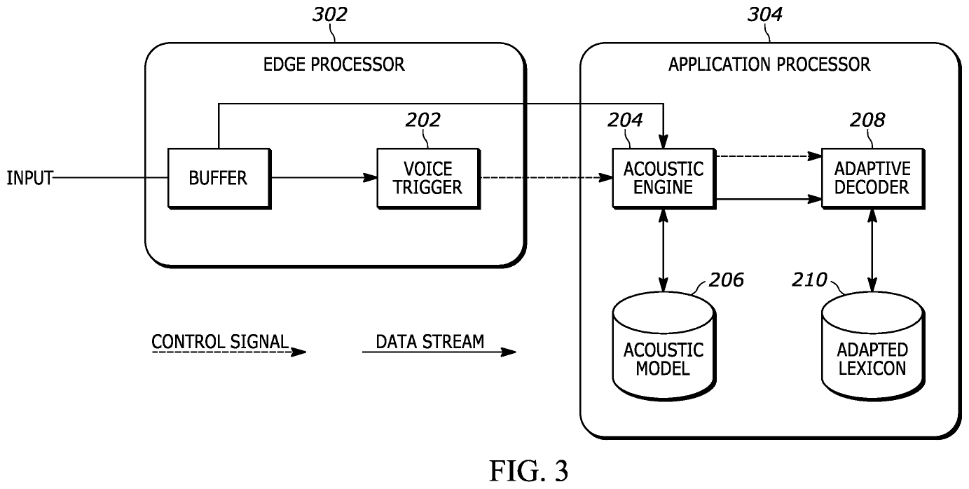

FIGS. 3-6 illustrate various configurations of the dynamic command recognition system 200 across an edge processor and an application processor. Referring to FIG. 3, edge processor 302 is shown to implement the trigger module 202 while application processor 304 implements the acoustic engine 204 and adaptive decoder 208. The edge processor 302 may be configured to receive the input audio stream, recognize a chosen trigger phrase, and send a control signal to the application processor 304 with an indication of a start of a potential command. Application processor 304 may then analyze the audio stream and identify the spoken command.

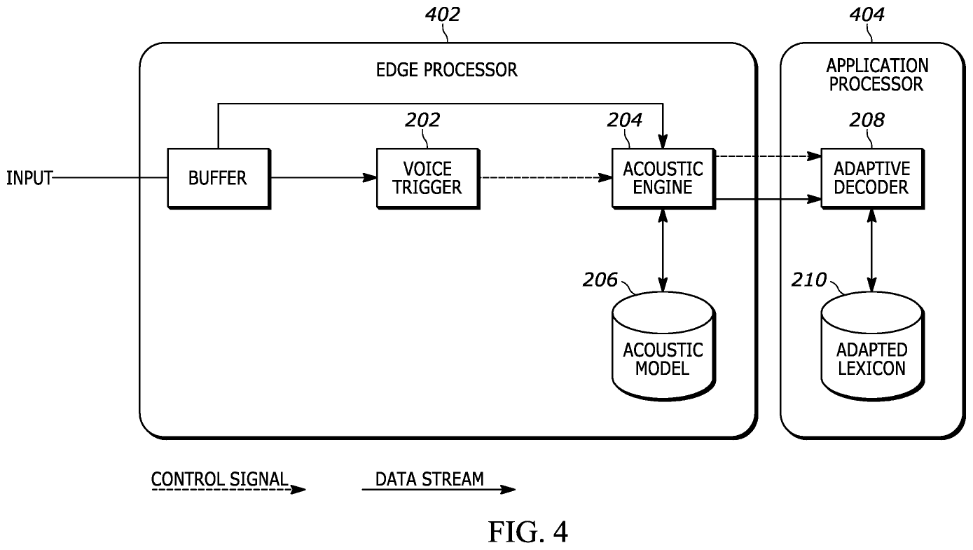

Referring to FIG. 4, edge processor 402 is shown to include both the trigger module 202 and the acoustic engine 204, and application processor 404 implements the adaptive decoder 208. Edge processor 402 may be configured to receive an input audio stream, identify a trigger phrase, and generate a sequence of graphemes from the input audio stream. The edge processor 402 may send the grapheme sequence to the application processor 404, where the application processor 404 determines the intended command from the grapheme sequence.

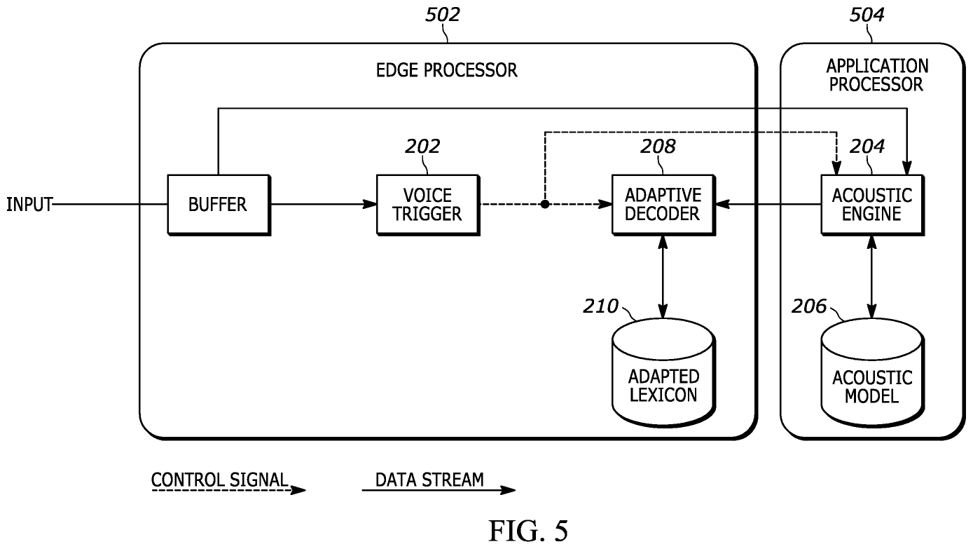

Referring to FIG. 5, an embodiment is shown where edge processor 502 includes the trigger module 202 and the adaptive decoder 208, and application processor 504 implements the acoustic engine 204. The edge processor 502 may be configured to receive the input audio stream and identify a trigger phrase from the audio stream. The edge processor 502 may be configured to send a control signal to application processor 504 initiating processing of the audio stream by the application processor 504 and a start point of the potential command. Application processor 504 may be configured to generate a sequence of graphemes based on the audio stream and send the grapheme sequence to edge processor 502. Edge processor 502 may be further configured to determine an intended command from the sequence of graphemes and send the intended command to application processor 504.

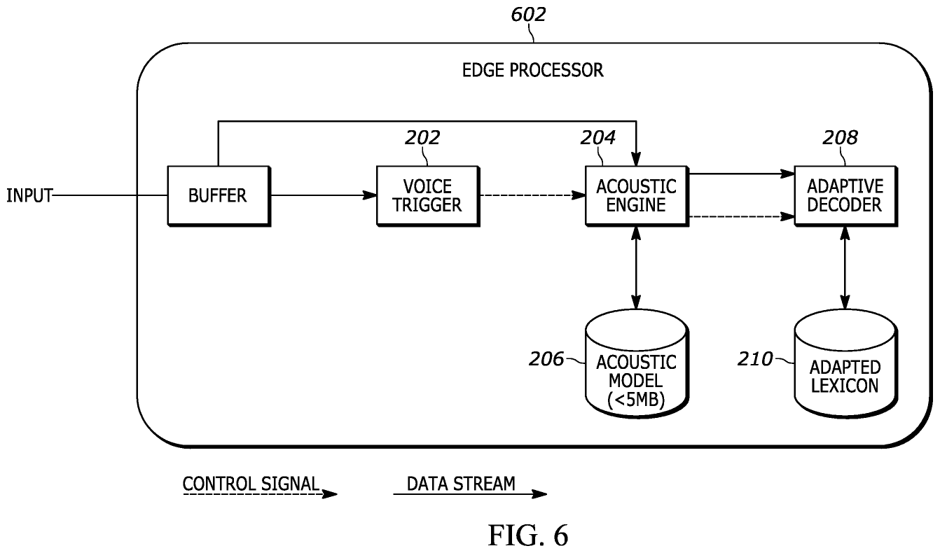

Referring to FIG. 6, an embodiment is shown where edge processor 602 includes the trigger module 202, the acoustic engine 204, and the adaptive decoder 208. Thus, edge processor 602 performs full ASR processing for the input audio stream and sends the command to an application processor. Edge processor 602 may still be configured to communicate identified commands with an application processor (not shown).

Any of the application processors 304, 404, or 504, or any of edge processors 302, 402, 502, or 602 may be configured to execute a response to the identified command. In some embodiments, the application processor or edge processor are configured to send a control signal to another device in the device or system.

ASR Management System

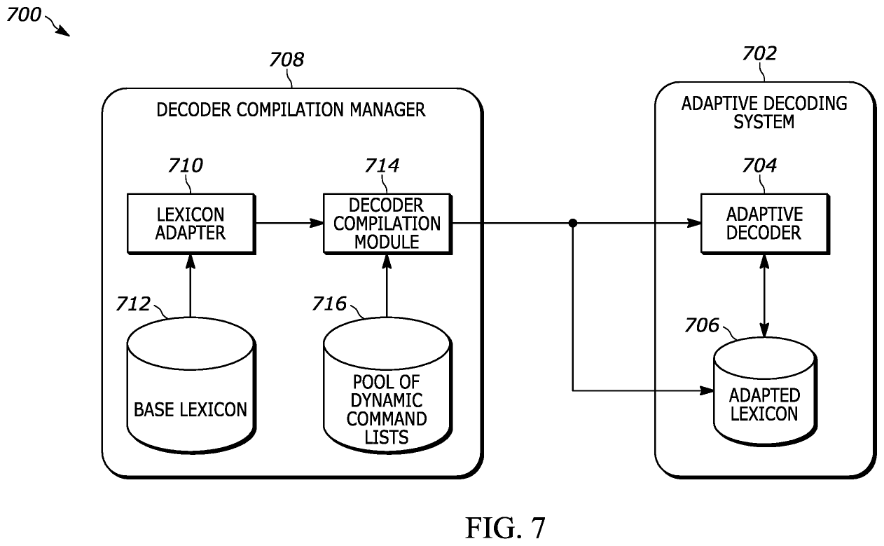

Referring now to FIG. 7, an ASR decoder management system 700 is shown, according to one embodiment. System 700 is shown to include an adaptive decoding system 702 and a decoder compilation manager 708. Adaptive decoding system 702 can include any component, feature, or configuration as discussed in relation to the adaptive ASR system 200. Decoder compilation manager 708 includes a lexicon adapter 710, base lexicon 712, decoder compilation module 714 (also referred to herein as decoder compiler), and a database 716 of one or more dynamic command lists. Decoder compilation manager 708 is configured to generate and send an adapted lexicon 706 to adaptive decoding system 702 to be used by an adaptive decoder 704 in ASR processing. Decoder compilation manager 708 may generally operate on an application processor, and adaptive decoding system 702 can be distributed across the application processor and/or an edge processor.

Decoder compilation manager 708 is configured to regulate updates or expansions of the adapted lexicon 706. Decoder compilation manager 708 may be configured to receive an indication of a change in state or context of a supported system. Decoder compilation manager 708 may send control signals to adaptive Decoding system 702 indicating the adaptive decoder 704 should be updated. Decoder compilation manager 708 may be configured to receive sample speech data or prompt a user to speech a sample command. Decoder compilation manager 708 may then use the sample speech data to update base lexicon 712 or adapted lexicon 706.

Lexicon adapter 710 generally updates or expands the base lexicon 712. The base lexicon 712 can be a generic or sophisticated lexicon comprising lexeme entries corresponding to a word, phrase, or grammar rule with associated grapheme pronunciations. Base lexicon 712 may be retrieved from a database in a network. In some embodiments, base lexicon 712 is stored on the application processor. Lexicon adapter 710 can add lexemes or grapheme pronunciations to the base lexicon 712. Base lexicon 712 may be expanded to include erroneous or non-standard grapheme sequences generated by a compressed acoustic model. Base lexicon 712 may also be expanded to recognize user-specific grapheme pronunciations.

Decoder compiler 714 is configured to compile the adaptive decoder 704 with the adapted lexicon 706. Adapted lexicon 706 may be compiled by decoder compiler 714 with a subset of base lexicon 712 to meet a memory constraint. Decoder compiler 714 may be configured to retrieve the subset of commands to be included in the adapted lexicon 706 from command database 716 based on a context or state of the device. Decoder compiler 714 may be configured to include the additional grapheme pronunciations added to the base lexicon 712 in the adapted lexicon 706. Decoder compiler 714 may be configured to generate an adapted language model using adapted lexicon 706.

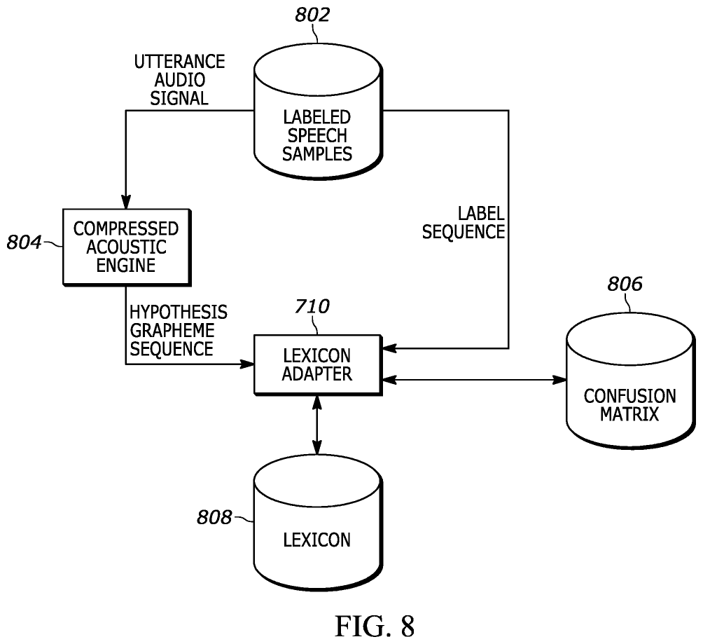

Referring now to FIG. 8, a block diagram for expanding a lexicon 808 is shown, according to one embodiment. The lexicon 808 is expanded such that erroneous or non-standard grapheme hypothesis sequences generated by an acoustic engine 804 implementing a compressed acoustic model can be associated with the intended command. Either a base lexicon or expanded lexicon can be expanded as discussed herein. Labelled speech samples 802 generally comprise an audio signal with a grapheme sequence corresponding to a spoken command or phrase and a command label indicating the spoken command. Labelled speech samples 802 may be retrieved from a database, stored responsive to live operation of an ASR system, or generated responsive to prompting a user to speak a particular command or phrase. The audio signals of the labelled speech samples 802 are used as input to the acoustic engine 804 to produce a hypothesis grapheme sequence.

Lexicon adapter 710 receives the hypothesis sequences from the acoustic engine 804 and compares one or more hypothesis sequences to one grapheme sequence associated with the command in the lexicon 808 corresponding to the command label of the labelled speech samples 802. Lexicon adapter 710 may be configured to generate and update a confusion matrix 806 to measure error rates of the acoustic engine over the set of speech samples. Confusion matrix 806 may be updated based on the comparison of the hypothesis sequences to the reference grapheme sequence. Lexicon adapter 710 updates or expands the lexicon 808. Lexicon adapter 710 may include additional lexicon or grapheme sequences to the entries in lexicon 808 based on the confusion matrix 806. In some embodiments, lexicon adapter 710 updates a language model of lexicon 808.

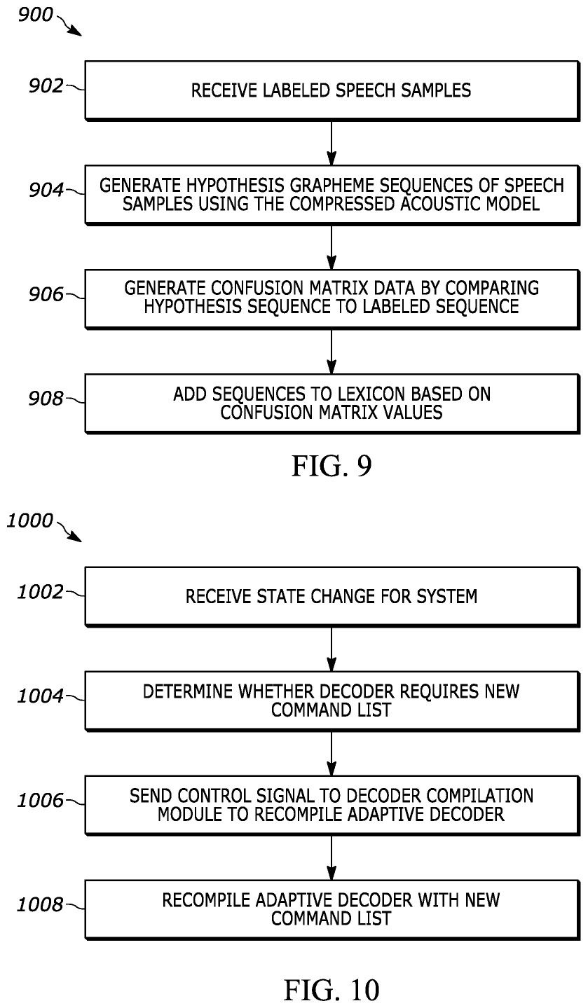

Referring now to FIG. 9, a method 900 for expanding an adaptive decoder is shown, according to some embodiments. Method 900 generally expands the adaptive decoder to recognize additional grapheme sequences as spoken commands. In some embodiments, the steps of method 900 are performed by Decoder compilation manager 708 and adaptive Decoding system 702.

At 902, labelled speech samples are received by a system expanding the adaptive decoder. Labelled speech samples generally comprise an audio signal with a spoken command or phrase and a command label indicating the spoken command. The command label may be a grapheme sequence and an indication of the intended command. Labelled speech samples may be retrieved from a database, stored responsive to live operation of an ASR system, or generated responsive to prompting a user to speak a particular command or phrase.

At 904, hypothesis grapheme sequences are generated for the labelled speech samples using an acoustic engine with a compressed acoustic model. In some embodiments, the audio signal of the labelled speech samples is sent to an acoustic engine configured with the compressed acoustic model to generate the hypothesis grapheme sequences. In some embodiments, the hypothesis grapheme sequences are sent to a decoder with a wide coverage language model to generated hypotheses.

At 906, model error data is generated by comparing the hypothesis grapheme sequences to the reference grapheme sequences in the labelled speech samples. Model error data may be generated over the entire sample data set. In some embodiments, the model error data is a prediction accuracy rate of the compressed acoustic model for the sample data set. In some embodiments, the model error data forms entries in a confusion matrix, wherein entries are entered in the confusion matrix based on the hypothesis grapheme sequences and reference grapheme sequences of the corresponding commands.

At 908, the adaptive decoder is expanded to more accurately recognize the speech samples that the original acoustic model recognizes with high error rate based on the confusion matrix. In some embodiments, the adaptive decoder is expanded based on hypothesis grapheme sequences with the highest value in matching the reference grapheme sequences as indicated in the confusion matrix of the model error data. In some embodiments, the most commonly-used grapheme sequences are used to expand the adaptive decoder. In some embodiments, the model error data is compared to a chosen threshold value, and hypothesis grapheme sequences with a model error value greater than the chosen threshold are added to the adaptive decoder responsive to the model error value exceeding the threshold value. A lexicon of the adaptive decoder may be updated or expanded. In some embodiments, a language model is recompiled to expand the adaptive decoder. The adaptive decoder may be expanded responsive to individual data samples or collectively responsive to the entire sample data set being processed.

In some embodiments of method 900, the user is prompted to speak one or more sample commands for processing by the adaptive ASR system. Audio signals of the sample command can be stored with an associated command label. Such embodiments provide the advantage to incorporate user-specific pronunciations in decoder adaption. In some embodiments, during operation of the adaptive ASR system, when two or more potential grapheme sequences have a similar probability, the user may be prompted to select which of two potential commands was actually spoken. An audio signal of the ambiguous spoken command may be stored as a speech sample with a command label that was indicated by the user. Accordingly, the ambiguous speech sample may be used to further refine and expand the adaptive ASR system.

Referring now to FIG. 10, a method 1000 to compile an adaptive decoder with a dynamic command list is shown, according to some embodiments. In some embodiments, the steps of method 1000 are performed by decoder compilation manager 708.

At 1002, a change in a state or context of a device is received. The change in state or context may be received from an application processor or another processing device in a system. In some embodiments, the state or context is determined based on data available to a processing system performing the decoder compilation management. States or contexts may generally be defined such that different command lists are recognized by the ASR system.

At 1004, a determination is made whether a new command list should be used. Command lists may be associated with a specific state or context. States and context may be organized in a tree such that commands associated with a general state or context can be supplemented with commands associated with a more specific state or context of the general state or context. Multiple states or context may be associated with a single command list. The determination may be based on a comparison of the command list associated with the previous state or context to the command list of the new state or context.

At 1006, a control signal is sent to a decoder compiler to recompile the adaptive decoder using the determined command list. The control signal may include an indication of the command list to compile the adaptive decoder. The control signal may be configured to schedule the compilation of the adaptive decoder immediately or during a low-use period of time, such as at night.

At 1008, the adaptive decoder is recompiled using the determined command list. A new lexicon may be sent to the adaptive decoder. In some embodiments, command entries are added to a lexicon used by the adaptive decoder. In some embodiments, a language model may be updated or generated to be used by the adaptive decoder. The decoder compilation management system may be configured to send the updated lexicon or language model to a separate processing device performing some of the functions of the ASR system.

### Configuration of the Exemplary Embodiments

It should be appreciated that the features, functions, and systems of the present application can be arrange in computing devices beyond those disclosed herein. For example, any of the components or processing of the adaptive ASR system can be implemented on the application processor, a back-end server, or separate server. It should also be appreciated that the modules and components of the adaptive ASR system can be implemented as hardware components within a processor, software instructions configured to cause a processor to execute a function, or a combination of hardware and software implementations.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. An apparatus, comprising:
an adaptive decoder configured to determine a command from a sequence of graphemes, the sequence of graphemes generated using a compressed acoustic model,
wherein the adaptive decoder can be expanded to recognize additional grapheme sequences associated with the command, and
wherein the additional grapheme sequences are hypothesis sequences generated by the compressed acoustic model using labeled speech utterances.

2. The apparatus of claim 1, wherein the adaptive decoder is expanded responsive to the hypothesis sequences being different than a label sequence associated with the labeled speech utterances.

3. The apparatus of claim 1, wherein the adaptive decoder comprises an adaptive lexicon, wherein the additional grapheme sequences are added to the adaptive lexicon.

4. The apparatus of claim 3, wherein the adaptive decoder comprises an adaptive language model, wherein the additional grapheme sequences are used to generate the adaptive language model.

5. The apparatus of claim 1, further comprising a trigger module configured to recognize a spoken keyword in an audio signal and send a control signal and a timestamp to the adaptive decoder responsive to recognizing the spoken keyword.

6. The apparatus of claim 1, wherein the decoder is configured to use a dynamic command list.

7. The apparatus of claim 6, wherein the dynamic command list is associated with a state or context of the apparatus.

8. The apparatus of claim 1, further comprising an acoustic engine configured to generate the sequence of graphemes.

9. The apparatus of claim 8, wherein the acoustic engine is implemented by a digital signal processor and the adaptive decoder is implemented by an application processor separate from the digital signal processor.

10. The apparatus of claim 8, wherein the adaptive decoder is implemented by a digital signal processor and the acoustic engine is implemented by an application processor separate from the digital signal processor.

11. The apparatus of claim 8, wherein the acoustic engine and the adaptive decoder are implemented by a digital signal processor.

12. The apparatus of claim 8, wherein the acoustic engine and the adaptive decoder are implemented by an application processor.

13. An audio processing system, comprising:
a decoder module configured to determine a command from a sequence of graphemes generated by a compressed acoustic model; and
a decoder compilation module configured to:
receive a speech utterance and a label grapheme sequence corresponding to the speech utterance;
generate a hypothesis grapheme sequence for the speech utterance using the compressed acoustic model;
determine an error measurement between the hypothesis grapheme sequence and the label grapheme sequence; and
expand the decoder module to recognize the hypothesis grapheme sequence responsive to the error measurement exceeding a threshold.

14. The processing system of claim 13, wherein the decoder compilation module is further configured to generate a confusion matrix for the compressed acoustic model, wherein the error measurement corresponds to a value in the confusion matrix.

15. The processing system of claim 13, wherein updating the decoder module comprises adding the hypothesis grapheme sequence to an adapted lexicon used by the decoder module.

16. The processing system of claim 15, wherein expanding the decoder module comprises recompiling a language model used by the decoder module using the hypothesis sequence.

17. The processing system of claim 13, wherein the command is included in a first set of commands the decoder module is configured to recognize, wherein the decoder compilation module is further configured to update the decoder module to recognize a second set of commands.

18. The processing system of claim 17, wherein the first set of commands is stored in the decoder module, wherein the second set of commands replaces the first set of commands.

19. The processing system of claim 18, wherein the first set of commands and the second set of commands are associated with a state or context of an application system.

20. The processing system of claim 13, further comprising a trigger module configured to recognize a spoken keyword in an audio signal and send a control signal to the decoder module responsive to recognizing the spoken keyword.

21. A method, comprising:
receiving a speech utterance and a command label corresponding to the speech utterance;
generating a hypothesis grapheme sequence for the speech utterance using a compressed acoustic model;
determining an error measurement between the hypothesis grapheme sequence to the command label;
recompiling an adaptive decoder to recognize the hypothesis grapheme sequence responsive to the error measurement exceeding a threshold; and
determining, using the recompiled adaptive decoder, a command from a sequence of graphemes, the sequence of graphemes generated by the compressed acoustic model.

22. The method of claim 21, wherein recompiling the adaptive decoder comprises adding the hypothesis grapheme sequence to an adapted lexicon used by the adaptive decoder.

23. The method of claim 22, wherein recompiling the adaptive decoder comprises generating a language model used by the decoder module using the hypothesis sequence.

24. The method of claim 21, wherein the command is included in a first set of commands the decoder module is configured to recognize, the method further comprising recompiling the adaptive decoder to recognize a second set of commands.

25. A processing system, comprising:
an adapted lexicon comprising a first set of commands;
a decoder configured to use the adapted lexicon and determine a command from the grapheme sequence, the command included in the adapted lexicon; and
a decoder compiler configured to:
determine a change of state or context of an application of the processing system;
determine a second set of commands for the adapted lexicon, wherein the second set of commands is associated with a new state or context; and
recompile the adapted lexicon with the second set of commands.

26. A method, comprising:
compiling a decoder to recognize a first set of commands, the first set of commands associated with a first state;
receiving a change of state of a device application;
determining a second set of commands to compile on the decoder, wherein the second set of commands is associated with a second state of the device application; and
recompiling the decoder with the second set of commands.
